(19) United States
(12) Patent Application Publication
(10) Pub. No.: US 2015/0312764 A1
(43) Pub. Date: Oct. 29, 2015

(54) METHOD AND APPARATUS FOR THEFT DETECTION OF A MOBILE DEVICE

(71) Applicant: HERE Global B.V., Veldhoven (NL)

(72) Inventors: Marko Tapio TUUKKANEN, Schlenzer (DE); Jerome BEAUREPAIRE, Berlin (DE)

(73) Assignee: HERE Global B.V., Veldhoven (NL)

(21) Appl. No.: 14/263,555

(22) Filed: Apr. 28, 2014

(51) Int. Cl. H04W 12/08; G08B 13/22

(52) U.S. Cl. CPC H04W 12/08; G08B 13/22

(57) ABSTRACT

An approach is provided for causing, at least in part, a detection of at least one notification within proximity of at least one device. The approach involves causing, at least in part, a detection of at least one movement of the at least one device after the detection. The approach further involves causing, at least in part, an initiation of at least one alternative operating mode for the at least one device based, at least in part, on the at least one notification and the at least one movement.

### BACKGROUND

The desire for miniaturization of electronics has resulted in compact and lightweight mobile devices that are easily transportable. Such portable mobile devices are being widely used for storing and exchanging of confidential data, and may carry important data that are prone to theft. Furthermore, recent innovation in mobile commerce has enabled users to conduct many transactions via their mobile devices, for example, online banking, online purchases etc. Needless to mention, the attributes that make mobile devices easy to carry and use, opens them to a range of attacks. While the authorized owner of a portable mobile device may conveniently carry the device almost anywhere, so can a thief.

### SOME EXAMPLE EMBODIMENTS

Therefore, there is a need for an approach for triggering a defensive operating mode in a device upon detection of an alarm and a movement of a device. In one embodiment, a defensive operating mode is one example of the alternative operating mode.

According to one embodiment, a method comprises causing, at least in part, a detection of at least one notification within proximity of at least one device. The method also comprises causing, at least in part, a detection of at least one movement of the at least one device after the detection. The method further comprises causing, at least in part, an initiation of at least one alternative operating mode for the at least one device based, at least in part, on the at least one notification and the at least one movement.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, a detection of at least one notification within proximity of at least one device. The apparatus is also caused to cause, at least in part, a detection of at least one movement of the at least one device after the detection. The apparatus is further caused to cause, at least in part, an initiation of at least one alternative operating mode for the at least one device based, at least in part, on the at least one notification and the at least one movement.

According to another embodiment, a computer-readable storage medium carries one or more sequences of one or more instructions which, when executed by one or more processors, cause, at least in part, an apparatus to cause, at least in part, a detection of at least one notification within proximity of at least one device. The apparatus is also caused to cause, at least in part, a detection of at least one movement of the at least one device after the detection. The apparatus is further caused to cause, at least in part, an initiation of at least one alternative operating mode for the at least one device based, at least in part, on the at least one notification and the at least one movement.

According to another embodiment, an apparatus comprises means for causing, at least in part, a detection of at least one notification within proximity of at least one device. The apparatus also comprises means for causing, at least in part, a detection of at least one movement of the at least one device after the detection. The apparatus further comprises means for causing, at least in part, an initiation of at least one alternative operating mode for the at least one device based, at least in part, on the at least one notification and the at least one movement.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of triggering a defensive operating mode in a device upon detection of an alarm and a movement of a device, according to one embodiment;

FIG. 2 is a diagram of the components of the identification platform 109, according to one embodiment;

FIG. 3 is a flowchart of a process for triggering a defensive operating mode in a device upon detection of an alarm and a movement of a device, according to one embodiment.

FIG. 4 is a flowchart of a process for determining the duration for an and the movement distance for a UE 101 to initiate a defensive mode of operation, and causing a transmission of a message regarding the alarm to neighboring UE 101s, according to one embodiment.

FIG. 5 is a flowchart of a process for causing a detection of an authorized user to return the UE 101 to its normal operating mode, according to one embodiment.

FIG. 6 is a flowchart of a process for causing a detection of neighboring devices to initiation defensive operating mode at the neighboring devices, according to one embodiment.

FIGS. 7 A-B are flow diagrams for triggering a defensive operating mode in a device upon detection of an alarm and a movement of a device, according to one example embodiment.

FIGS. 8 A-C are pictorial representations of a scenario wherein the identification platform 109 triggers a defensive operating mode in a UE 101 upon detecting an alarm and a movement of a UE 101, according to one example embodiment.

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for triggering a defensive operating mode in a device upon detection of an alarm and a movement of a device are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

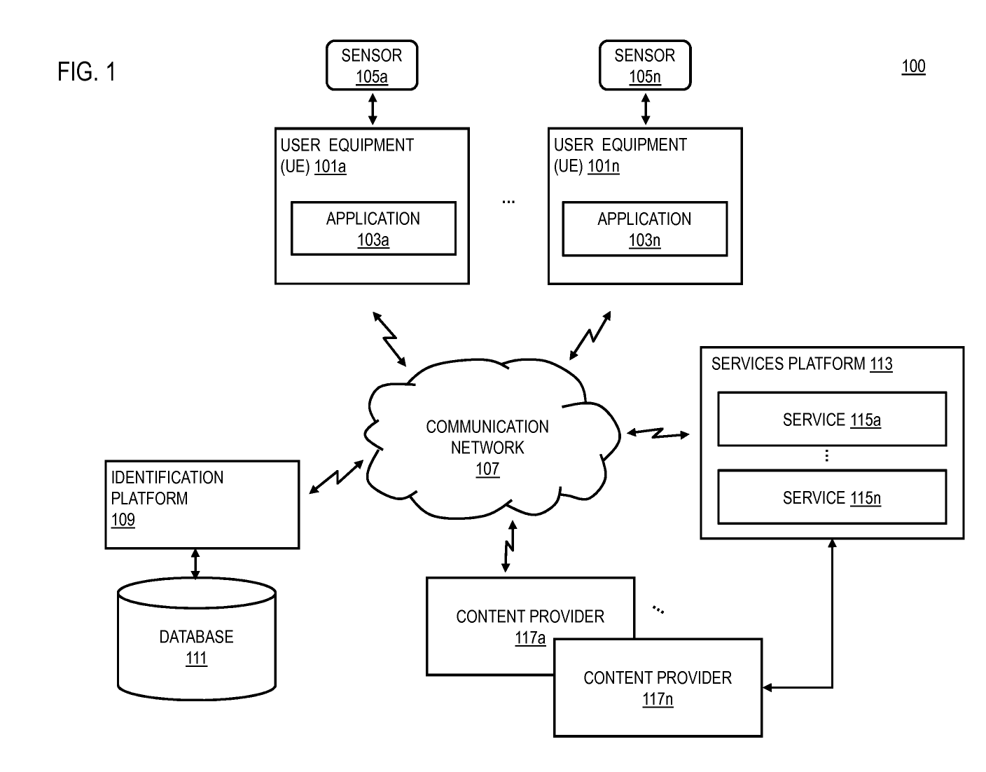

FIG. 1 is a diagram of a system capable of triggering a defensive operating mode in a device upon detection of an alarm and a movement of a device, according to one embodiment. The popularity of portable mobile devices with advanced capabilities like those of personal computers, and the relatively lax security measures makes them attractive targets for theft. Since, consumers are using mobile devices for an increasing number of activities and often store sensitive data, they may either lose all the data stored in the stolen mobile device or a sophisticated thief may defeat most security features to gain access to the confidential information stored therein. A thief may publicly reveal or sell any personal information extracted from the mobile device, including the user's information to access the bank account or credit card account. Though numerous mobile devices have been stolen from one or more vehicles, there is still no mechanism to utilize the presence of a vehicle and the alarms of the vehicle to protect the mobile devices.

To address this problem, a system 100 of FIG. 1 introduces the capability to trigger a defensive operating mode in a device upon detection of an alarm and a movement of a device. This solution presents a mechanism in which the car alarm and proximity is used to switch the user device to a defensive mode to prevent the thief from switching off the device or being aware of the user device being tracked.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, augmented reality glasses, virtual reality glasses or any combination thereof, including the accessories and peripherals of these devices, or any combination thereof. It is also contemplated that the UE 101 can support any type of interface to the user (such as “wearable” circuitry, etc.). In one embodiment, a virtual or augmented reality device may comprise of at least one processor, and at least one memory including computer program code for one or more computer programs configured to monitor position and/or movements of one or more users within the at least one vehicle. In one embodiment, the one or more vehicles may have cellular or WiFi connection either through the inbuilt communication equipment or from the UE 101 associated with the vehicles. The applications 103 may assist in conveying sensor information via the communication network 107.

By way of example, the applications 103 may be any type of application that is executable at the UE 101, such as location-based service applications, content provisioning services, camera/imaging application, media player applications, social networking applications, navigation applications, mapping application, calendar applications, and the like. In one embodiment, one of the applications 103 at the UE 101 may act as a client for the identification platform 109 and may perform one or more functions associated with the functions of the identification platform 109 by interacting with the identification platform 109 over the communication network 107.

By way of example, the sensors 105 may be any type of sensor. In certain embodiments, the sensors 105 may include, for example, a global positioning sensor for gathering location data (e.g., GPS), a network detection sensor for detecting wireless signals or receivers for different short-range communications (e.g., Bluetooth, WiFi, Li-Fi, near field communication etc.), temporal information, a camera/imaging sensor for gathering image data, an audio recorder for gathering audio data, and the like. In one scenario, the sensors 105 may include, light sensors, oriental sensors augmented with height sensor and acceleration sensor, tilt sensors, moisture sensors, pressure sensors, audio sensors (e.g., microphone), etc. In another scenario, sensors 105 may include passive infrared motion detectors, ultrasonic detectors, microwave detectors, glass break detector, vibration or inertia sensors, and any other security sensors.

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the identification platform 109 may be a platform with multiple interconnected components. The identification platform 109 may include multiple servers, intelligent networking devices, computing devices, components and corresponding software for triggering a defensive operating mode in a device upon detection of an alarm and a movement of a device. In one embodiment, the identification platform 109 may cause, at least in part, a detection of at least one triggering of at least one alarm within proximity of at least one device. In another embodiment, the identification platform 109 may cause, at least in part, a detection of at least one movement of the at least one device after the detection. In a further embodiment, the identification platform 109 may cause, at least in part, an initiation of at least one defensive operating mode for the at least one device based, at least in part, on the at least one alarm and the at least one movement. In one example embodiment, the identification platform 109 may activate an alarm in a vehicle upon detecting a break-in through the front window of the vehicle. Then, the identification platform 109 may transmit the information of the alarm to the at least one UE 101 within the vehicle. Subsequently, the identification platform 109 may instruct a UE 101 to go in a defensive operating mode upon detecting a movement of the UE 101 from the vehicle after the alarm has been triggered. In one scenario, a defensive operating mode may involve locking the device from user input, switching off the display, starting the audio/video recording and sharing of the audio/video recording, and sharing of the device location. In another scenario, when a UE 101 is on a defensive operating mode a thief cannot detect whether a UE 101 is switched off or on, as professional thieves often switches-off the UE 101 to prevent them from being located. In addition, the UE 101 may display the “low battery” indication to the thief if trying to switch on the device, thereby fooling the thief to think that the device is switched-off. Thereafter, the identification platform 109 may cause a UE 101 to record any activities in an audio and/or video format. The recording alongside device location information is simultaneously shared with a cloud service in which authorities like police could have instant access. As an alarm of a vehicle may also reach the police, it allows the police to associate the vehicle alarm with the movement of the UE 101, thereby catching the thief while moving away from the vehicle.

In one embodiment, when the UE 101 is returned or discovered by the rightful owner, the audio detection may be used to identify the user based on his/her voice. Then, the identification platform 109 may cause a presentation of a user interface to switch the UE 101 to a normal mode. In one scenario, the user verification process is based, at least in part, on predefined values, wherein predefined values include, at least in part, a preset username and password combination, a pin code, one or more identifiers, other authentication mechanisms, or a combination thereof. In one example embodiment, the identification platform 109 may pair the UE 101 with at least one vehicle, and upon detecting an alarm the UE 101 may automatically lock itself with a PIN request. In addition, the UE 101 may automatically start sharing its location information with a server. In another scenario, unlocking a UE 101 or returning to a normal operating mode after the UE 101 detects the authenticated user may also be dependent and associated with the location information. In one example embodiment, if the location information of a UE 101 matches the residence information of the authorized user, the UE 101 may unlock itself and/or may return to a normal operating mode. In a further scenario, if the location of the UE 101 matches the location of a police station, the UE 101 may return to a normal operating mode and may provide required information to identify the authorized user. In one example embodiment, a thief of a UE 101 is captured and taken to the nearby police station, a policeman may easily find the rightful owner of the UE 101 or may access any records from the UE 101 when the UE 101 returns to a normal operating mode upon detecting the location information of the police station.

In one embodiment, the identification platform 109 may determine a physical form factor from among the plurality of physical form factors based, at least in part, on a policy, one or more sensor information, or a combination thereof. For example, the UE 101 may change its shape upon detecting an alarm to camouflage itself from a thief. In other example embodiment, the identification platform 109 may implement various security measures to prevent a UE 101 from being stolen, for example, a UE 101 may spread a bad smell upon detecting an alarm, a UE 101 may automatically roll itself and may lock itself to prevent unrolling upon detecting an alarm, a UE 101 may prevent unauthorized user from removing the batteries via electromagnets etc. In one scenario, the identification platform 109 may cause an activation of electromagnets to prevent thieves from stealing the UE 101 from a vehicle, for example, the electromagnets may either lock a UE 101 tight so that it is hard for a thief to steal it, or may wipe and damage the devices of the thieves with the magnetic fields.

In one embodiment, the identification platform 109 may create the database 111 wherein the determined information, for example, alarm selection information, proximity information, movement pattern information, authorized user information, and/or location information may be stored. The information may be any multiple types of information that can provide means for aiding in the content provisioning and sharing process.

The services platform 113 may include any type of service. By way of example, the services platform 113 may include location based services, navigation services, mapping services, travel planning services, social networking services, content (e.g., audio, video, images, etc.) provisioning services, application services, storage services, contextual information determination services, information (e.g., weather, news, etc.) based services, etc. In one embodiment, the services platform 113 may interact with the UE 101, the identification platform 109 and the content providers 117 to supplement or aid in the processing of the content information to triggering a defensive operating mode in a device.

By way of example, the services 115 may be an online service that reflects interests and/or activities of users. In one scenario, the services 115 provide representations of each user (e.g., a profile), his/her social links, and a variety of additional information. The services 115 allow users to share location information, activities information, contextual information, historical user information and interests within their individual networks, and provides for data portability.

The content providers 117 may provide content to the UE 101, the identification platform 109, and the services 115 of the services platform 113. The content provided may be any type of content, such as textual content, audio content, video content, image content, etc. In one embodiment, the content providers 117 may provide content that may supplement content of the applications 103, the sensors 105, or a combination thereof. By way of example, the content providers 117 may provide content that may aid in triggering a defensive operating mode in a device upon detection of an alarm and a movement of a device. In one embodiment, the content providers 117 may also store content associated with the UE 101, the identification platform 109, and the services 115 of the services platform 113. In another embodiment, the content providers 117 may manage access to a central repository of data, and offer a consistent, standard interface to data.

By way of example, the UE 101, the identification platform 109, the services platform 113, and the content providers 117 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

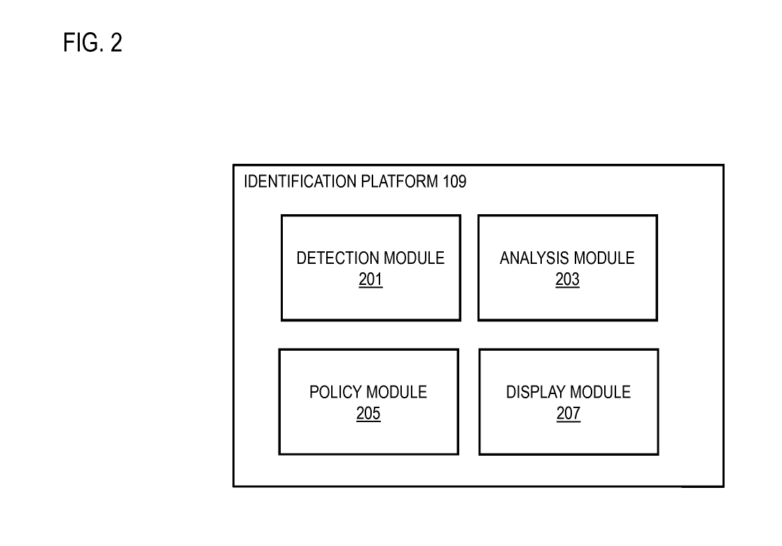

FIG. 2 is a diagram of the components of the identification platform 109, according to one embodiment. By way of example, the identification platform 109 includes one or more components for triggering a defensive operating mode in a device upon detection of an alarm and a movement of a device, according to one embodiment. It is contemplated that the functions of these components may be combined in one or more components or performed by other components of equivalent functionality. In this embodiment, the identification platform 109 includes a detection module 201, an analysis module 203, a policy module 205, and a display module 207.

In one embodiment, the detection module 201 may detect an alarm within proximity of at least one UE 101. The detection module 201 may detect the proximity for a UE 101 based on one or more sensors, a local or network based connectivity, or a combination thereof. In one scenario, the detection module 201 may detect a break-in whereupon an alarm is triggered on. The information of the alarm is then transmitted to a UE 101 within a nearby area. In another embodiment, the detection module 201 may detect movement of a device, and may correlate the movement of the device with the detected alarm. In one scenario, the detection module 201 may detect if a UE 101 is moved away from the proximate area after the alarm has been triggered. In a further embodiment, the detection module 201 may detect an authorized user of a device within close proximity by at least one biometric technology, for example, an audio detection may be used to recognize the user based on the voice. In another embodiment, the detection module may detect other hostile environment for a UE 101, for example, UE 101 is carried to a place it has never travelled before, detecting a usage pattern that is different from the authorized user. In a further embodiment, the detection module 201 may detect one or more stolen objects within a vehicle and/or a structure, whereupon the detection module 201 may communicate the detected information to one or more devices associated with the nearby vehicles and/or structures. Such information enables the nearby vehicles and/or structures to attempt to protect those objects from being stolen, if applicable. In one example embodiment, if a thief steals an airbag embedded in the steering wheels of a vehicle, the detection module 201 may detect that an airbag has been stolen, and may transmit this information to the neighboring vehicles.

In one embodiment, the analysis module 203 may determine whether the triggered alarm is associated with a proximate area wherein a UE 101 is located. Then, the analysis module may connect a UE 101 with the alarm. In another embodiment, the analysis module 203 may select one or more type of alarms that may trigger the UE 101 to go to a defensive mode. In a further embodiment, the analysis module 203 may connect an alarm with the location information of a UE 101, thereby allowing law enforcement agencies to directly associate the UE 101 to a specific alarm. In one scenario, the analysis module 203 may cause a recording and a sharing of device location information, the audio information, the video information, or a combination thereof to assist in tracking a UE 101.

In one embodiment, the policy module 205 may activate a defensive operating mode for at least one UE 101 based, at least in part, on the triggering of a type of alarm, the movement pattern of at least one UE 101, or a combination thereof. In another embodiment, the policy module 205 may cause one or more neighboring devices to be paired together, whereby specific alarm and the movement of the first device can trigger the other devices to go to a defensive operating mode. In addition, one or more neighboring devices can share data between each other to ensure the audio and video recorded is shared with the cloud service. In one scenario, the policy module 205 may pair one or more neighboring vehicles, wherein the first vehicle may inform the other nearby vehicles of the triggered alarm, and the neighboring vehicles may alert their respective UE 101. This enables the neighboring UE 101's within the neighboring vehicles to change to a defensive mode prior to the vehicle alarm being triggered. In a further embodiment, the policy module 205 may implement the location of the at least one vehicle when an alarm is triggered to influence the behavior of a UE 101, for example, if a vehicle is in a location that is considered safe (e.g., a private parking garage), the defensive operating mode may be limited to locking of the phone.

In one embodiment, the display module 207 may cause a presentation of a false output to prevent an unauthorized user from switching off the UE 101 or being aware of the UE 101 is being tracked. In one scenario, the UE 101 may present the “low battery” indication to the unauthorized user trying to switch-on the device, thereby deceiving the unauthorized user to think that the device is switched off. In another embodiment, the display module 207 may cause a deactivation of at least one display of the UE 101, and the power button of the at least one UE 101. In one scenario, the UE 101 may again present the “low battery” indication to the unauthorized user, thereby making them believe that low battery is the reason that they cannot switch-on the UE 101. In another scenario, the display module 207 may cause a false display of a broken screen for a UE 101 upon detection of an alarm, so that a thief who broke into a vehicle does not find interesting to take the UE 101 with him. In a further scenario, the display module 207 may change the color of the screen to the color of the surface it is being placed on to hide the UE 101 from the vision of the thief.

The above presented modules and components of the identification platform 109 can be implemented in hardware, firmware, software, or a combination thereof. Though depicted as a separate entity in FIG. 1, it is contemplated that the identification platform 109 may be implemented for direct operation by respective UE 101. As such, the identification platform 109 may generate direct signal inputs by way of the operating system of the UE 101 for interacting with the applications 103. In another embodiment, one or more of the modules 201-207 may be implemented for operation by respective UEs, as an identification platform 109, or combination thereof. Still further, the identification platform 109 may be integrated for direct operation with services 115, such as in the form of a widget or applet, in accordance with an information and/or subscriber sharing arrangement. The various executions presented herein contemplate any and all arrangements and models.

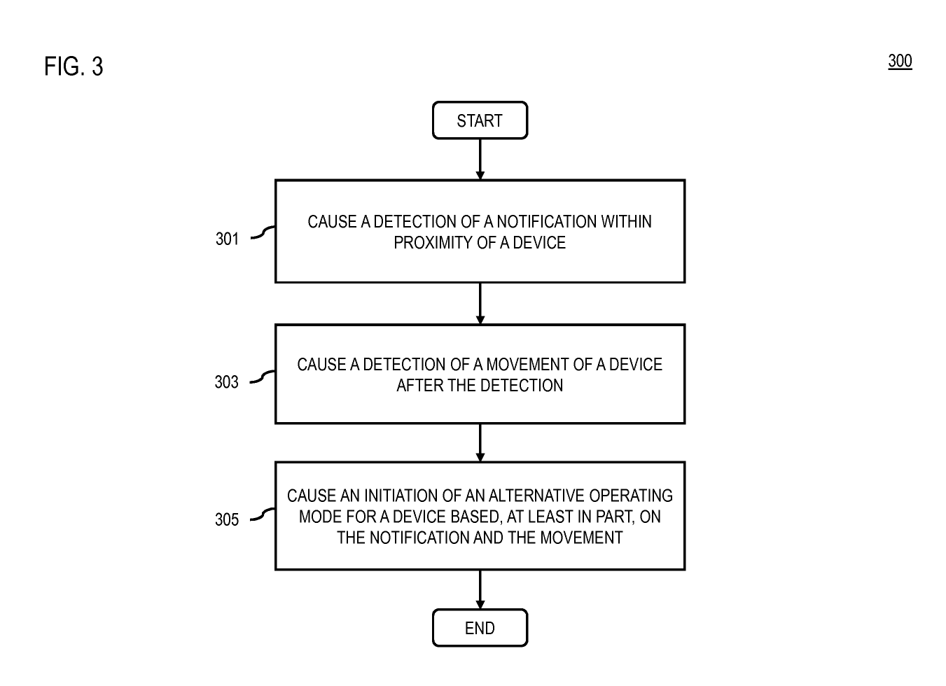

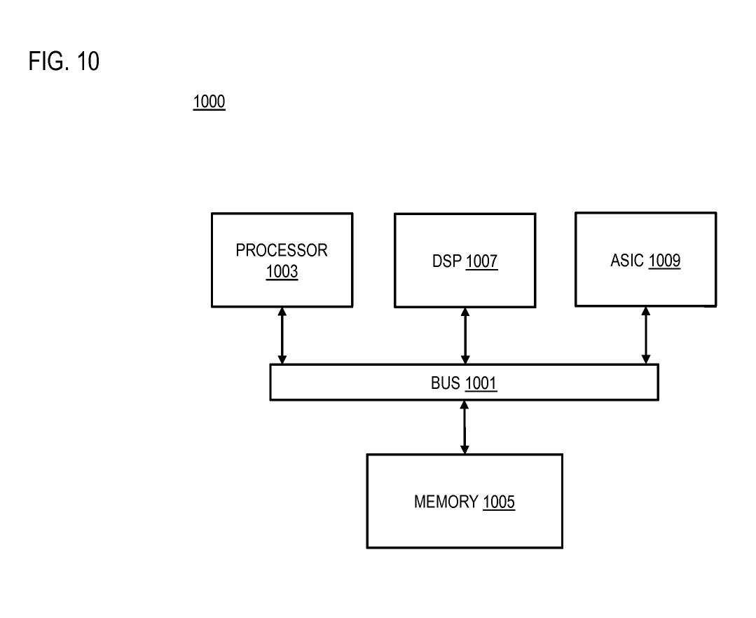

FIG. 3 is a flowchart of a process for triggering a defensive operating mode in a device upon detection of an alarm and a movement of a device, according to one embodiment. In one embodiment, the identification platform 109 performs the process 300 and is implemented in, for instance, a chip set including a processor and a memory as shown in FIG. 10.

In step 301, the identification platform 109 causes, at least in part, a detection of at least one notification within proximity of at least one device. In one embodiment, the at least one notification is associated with at least one alarm of at least one vehicle, at least one structure, or a combination thereof, and wherein the at least one device is located within the at least one vehicle, the at least one structure, or a combination thereof. In one example embodiment, at least one alarm may be any type of security alarm, for example, a vehicular alarm, a home or building alarm, etc. In one scenario, only certain types of alarms may be used, for example, the alarm for detecting that window of the car has been broken, this alarm is pretty reliable. In addition, such alarm is not the same as movement detection outside/inside of a vehicle.

In step 303, the identification platform 109 causes, at least in part, a detection of at least one movement of the at least one device after the detection. In one scenario, if a person steals a UE 101 then the location information and/or the contextual information of the thief may be stored in the database 111 for future reference. If a person has stolen phones before, then the identification platform 109 may know probable location of the stolen UE 101 by referring to the database 111.

In step 305, the identification platform 109 causes, at least in part, an initiation of at least one alternative operating mode for the at least one device based, at least in part, on the at least one notification and the at least one movement. In one embodiment, the at least one defensive operating mode includes, at least in part, (a) a deactivation of at least one display of the at least one device; (b) a deactivation of at least one power button of the at least one device; (c) an activation of a location recording, a media recording, or a combination thereof; (d) an activation of a sharing the location recording, the media recording, or a combination thereof with one or more users, one or more authorities, one or more services, or a combination thereof; or (e) a combination thereof. In one example embodiment, the initiation of a defensive operating mode for a device is based on detection of hostile environments, for example, triggering of an alarm, a device being dropped out of a pocket, device travelling to a place it has never travelled before, a device recognizing usage patterns which is different from that of authorized user. In another example embodiment, the defensive operating mode may also comprise of a proactive alarm with high noise, and/or blinking of flashlights associated with a UE 101, a vehicle, a structure, and/or sending of theft notification to nearby UE 101s etc. In one scenario, when a UE 101 is in a defensive operating mode, the display is off and it may present an empty battery icon to the unauthorized user. This way, the unauthorized user may not switch-off the UE 101 to prevent it from being located as it would be very hard to detect that the phone is still active and powered on.

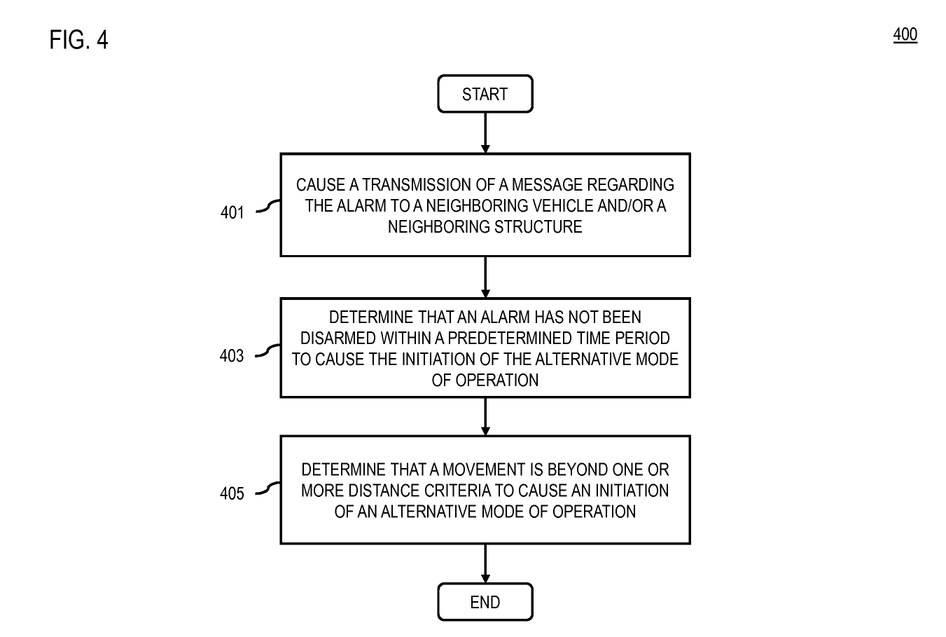

FIG. 4 is a flowchart of a process for determining the duration for an alarm and the movement distance for a UE 101 to initiate a defensive mode of operation, and causing a transmission of a message regarding the alarm to neighboring UE 101s, according to one embodiment. In one embodiment, the identification platform 109 performs the process 400 and is implemented in, for instance, a chip set including a processor and a memory as shown in FIG. 10.

In step 401, the identification platform 109 causes, at least in part, a transmission of at least one message regarding the at least one alarm to at least one neighboring vehicle, at least one neighboring structure, or a combination thereof, wherein the at least one message causes, at least in part, an initiation of the least one defensive operating mode for at least one other device associated with the at least one neighboring vehicle, the at least one neighboring structure, or a combination thereof. In one example embodiment, the identification platform 109 may scan for nearby UE 101s to potentially identify at least one device the intruder is carrying. If the Bluetooth or WiFi is on, it is potentially possible to locate the device of the at least one thief. In another example embodiment, if there is no network in an area wherein a UE 101 cannot transmit data to a cloud system, the UE 101 may send the data to the vehicle. The implementation of this process is based on a determination that a vehicle has less chances of being stolen as compared to a UE 101.

In step 403, the identification platform 109 determines that the at least one alarm has not been disarmed within a predetermined time period to cause, at least in part, the initiation of the at least one alternate mode of operation. In one scenario, the identification platform 109 may incorporate duration parameter to an alarm to determine a situation, for example, if the vehicular alarm is switched-off within 10 seconds, the identification platform 109 may not determine the situation to be hostile and may not instruct a UE 101 to be on a defensive operating mode.

In step 405, the identification platform 109 determines that the at least one movement is beyond one or more distance criteria to cause, at least in part, the initiation of the at least one alternate mode of operation. In one scenario, the identification platform 109 may incorporate proximity limitation between a UE 101 and the at least one vehicle to determine a situation, for example, if the UE 101 travels beyond the proximity limitation (10 feet) from the at least one vehicle, the identification platform 109 may determine the situation to be hostile and may instruct a UE 101 to be on a defensive operating mode.

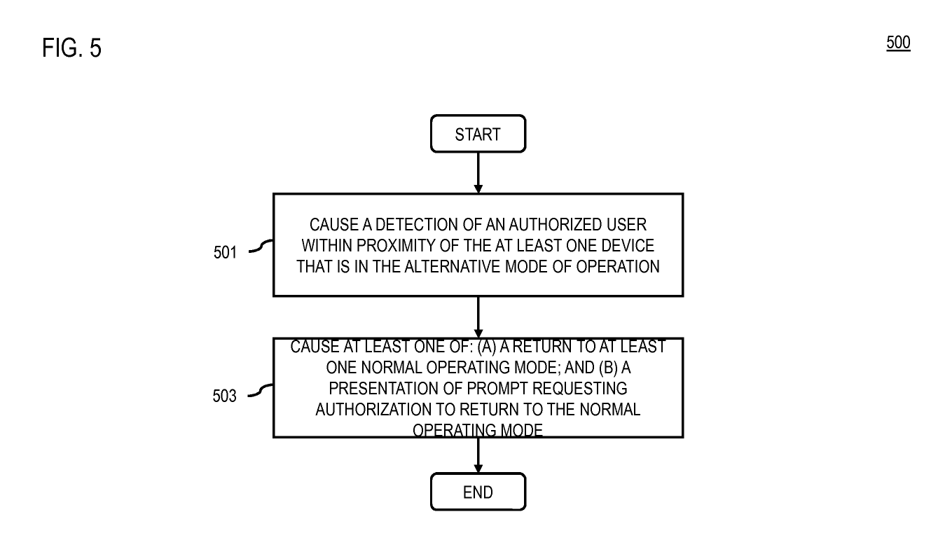

FIG. 5 is a flowchart of a process for causing a detection of an authorized user to return the UE 101 to its normal operating mode, according to one embodiment. In one embodiment, the identification platform 109 performs the process 500 and is implemented in, for instance, a chip set including a processor and a memory as shown in FIG. 10.

In step 501, the identification platform 109 causes, at least in part, a detection of at least one authorized user within proximity of the at least one device that is in the at least one alternative mode of operation. In one embodiment, the detection of the at least one authorized user is by at least one biometric technology, and wherein the at least one biometric technology includes, at least in part, a voice recognition technology, a facial recognition technology, or a combination thereof. In one scenario, when a UE 101 goes to a defensive operating mode, it may initiate a recording but may also pay attention for the voice of an authorized user. When the authorized users' voice is heard, the UE 101 may go back to its normal operation mode. Needless to mention, phone display and recordings consumes a lot of power, hence when a UE 101 is in a defensive operating mode it could conserve battery and may allow additional time for the location detection of the UE 101 (i.e. battery lasts longer so user/police has additional hours).

In step 503, the identification platform 109 causes at least one of: (a) a return to at least one normal operating mode; and (b) a presentation of prompt requesting authorization to return to the at least one normal operating mode. In one scenario, the identification platform 109 may detect a voice input and/or a touch input by an authorized user via one or more sensors. Then, the identification platform 109 may cause a display to the authorized user to approve the normal operating mode. The approval process may involve a user verification process wherein a user may need to enter a preset username and password combination.

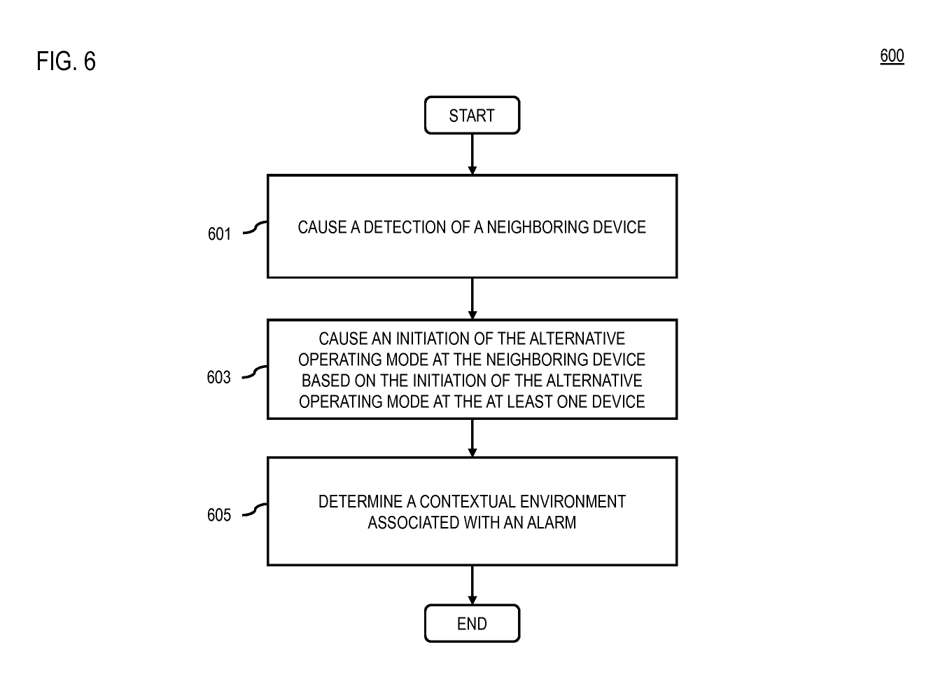

FIG. 6 is a flowchart of a process for causing a detection of neighboring devices to initiation defensive operating mode at the neighboring devices, according to one embodiment. In one embodiment, the identification platform 109 performs the process 600 and is implemented in, for instance, a chip set including a processor and a memory as shown in FIG. 10.

In step 601, the identification platform 109 causes, at least in part, a detection of at least one neighboring device. In one scenario, the identification platform 109 may detect one or more UE 101s within a certain proximity to transmit information on the hostile situation detected by the at least one UE 101. Then, the other UE 101s may also share the information on the hostile environment to a cloud service provider.

In step 603, the identification platform 109 causes, at least in part, an initiation of the at least one alternative operating mode at the least one neighboring device based, at least in part, on the initiation of the alternative operating mode at the at least one device. In one scenario, the identification platform 109 may detect one or more UE 101s within a certain proximity to transmit information on the hostile situation detected by the at least one UE 101. This method allows the other UE 101s to change to a defensive operating mode prior to any alarm being triggered or detected.

In step 605, the identification platform 109 determines at least one contextual environment associated with the at least one alarm, wherein the initiation of the at least one defensive operating mode, a selected type of the at least one defensive operating mode, or a combination thereof is based, at least in part, on the at least one contextual environment. In one example embodiment, as a defensive mechanism the identification platform 109 may cause at least one UE 101 to pass an electric shock to any unauthorized users upon detection of an alarm, hostile environment, or a combination thereof.

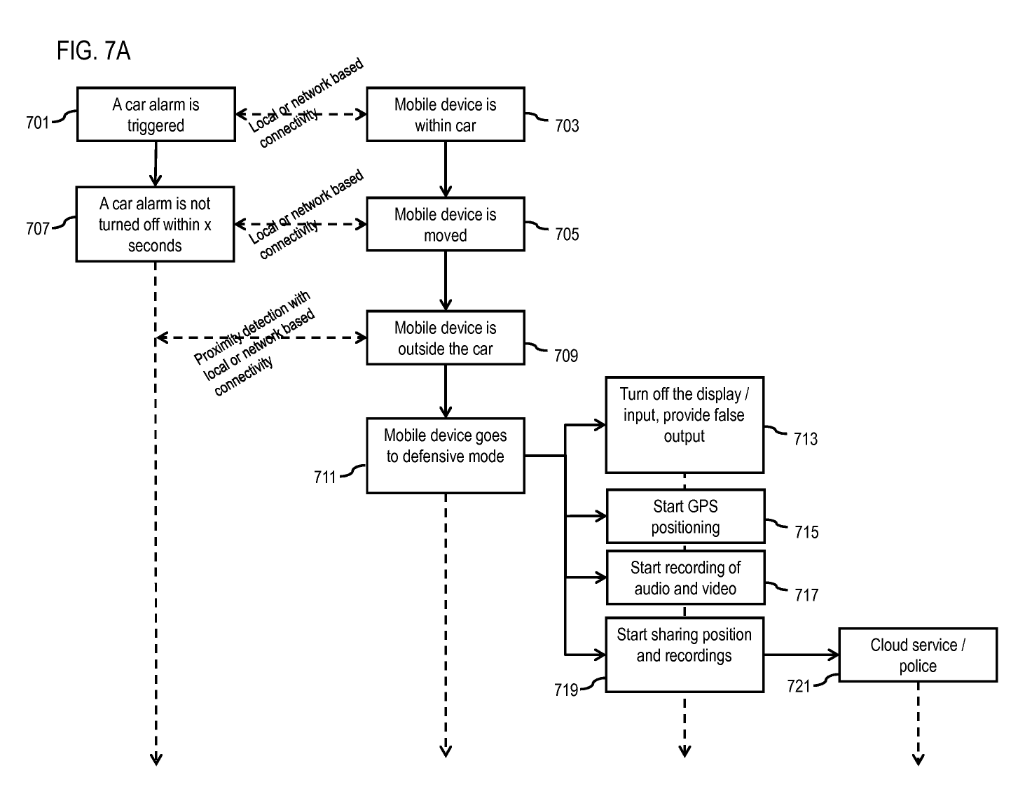

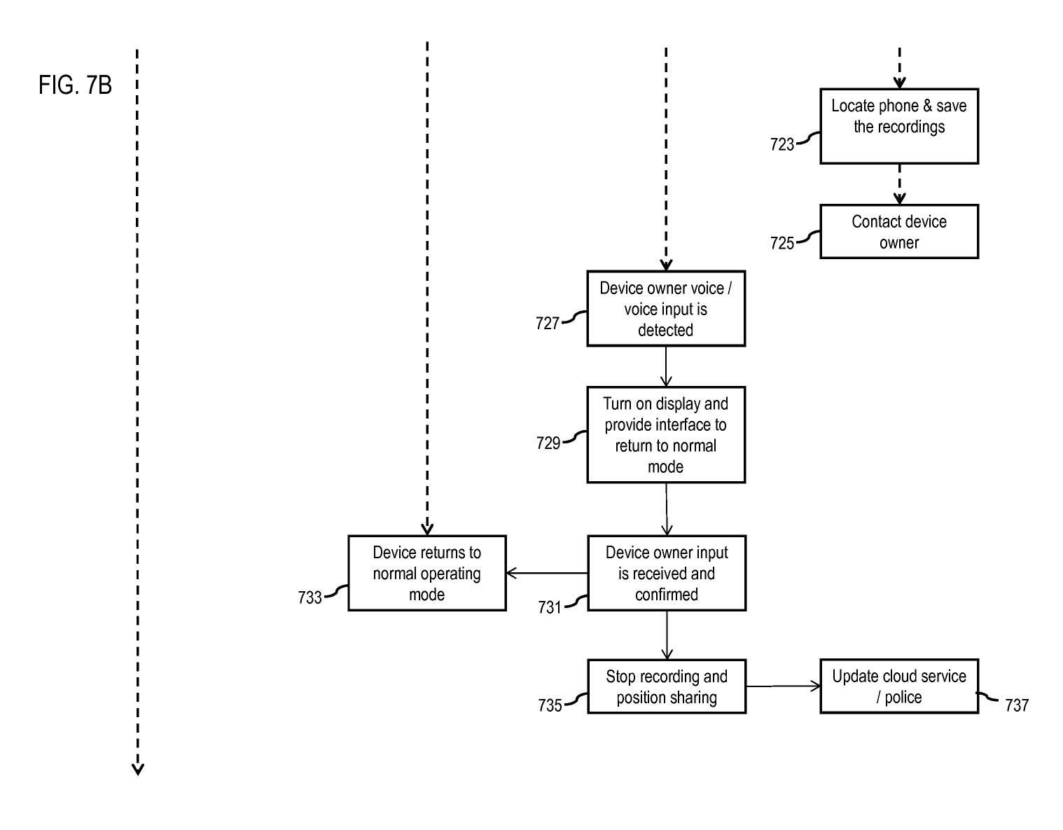

FIGS. 7 A-B are flow diagrams for triggering a defensive operating mode in a device upon detection of an alarm and a movement of a device, according to one example embodiment. In step 701, the identification platform 109 may trigger a vehicular alarm upon detecting a break-in. In step 703, the identification platform 109 may sense one or more UE 101 within a vehicle. In step 705, the identification platform 109 may detect movement pattern for the at least one UE 101 within a vehicle. In step 707, the identification platform 109 may correlate the movement of the at least one UE 101 with the vehicular alarm. The identification platform 109 may determine the duration for an alarm and the proximity of the UE 101 from the vehicle [step 709] via local or network based connectivity. In step 711, the identification platform 109 may cause the UE 101 to go into a defensive mode. In one scenario, the defensive operating mode for a UE 101 may comprise of UE 101 displaying a false output by turning off the display and/or input [713], initiating the GPS positioning [715], initiating an audio and/or a video recording of any activities [717], initiating a sharing of the location information and the recordings [719], or a combination thereof. In step 721, the identification platform 109 may share the location information and the recordings with a cloud service. The one or more law enforcement agencies (e.g. police) may access the cloud services for the location information and the recordings. In step 723, the law enforcement agencies may locate the UE 101 and may save the recordings for evidence purposes. In step 725, the law enforcement agencies may contact the device owner with information pertaining to the UE 101. In step 727, the identification platform 109 may identify the device owner via biometric technology, for example, a voice recognition technology, a facial recognition technology, or a combination thereof. In step 729, the identification platform 109 may switch-on the display and may provide a user interface to return to normal mode upon authentication of the identity of the user [step 731]. In step 733, the identification platform 109 may cause the device to go into a normal operating mode. Subsequently, the identification platform 109 may cause the UE 101 to stop recording any further activities [735] and sharing of the location information [735]. In step 737, the identification platform 109 may update the information in the cloud service accordingly.

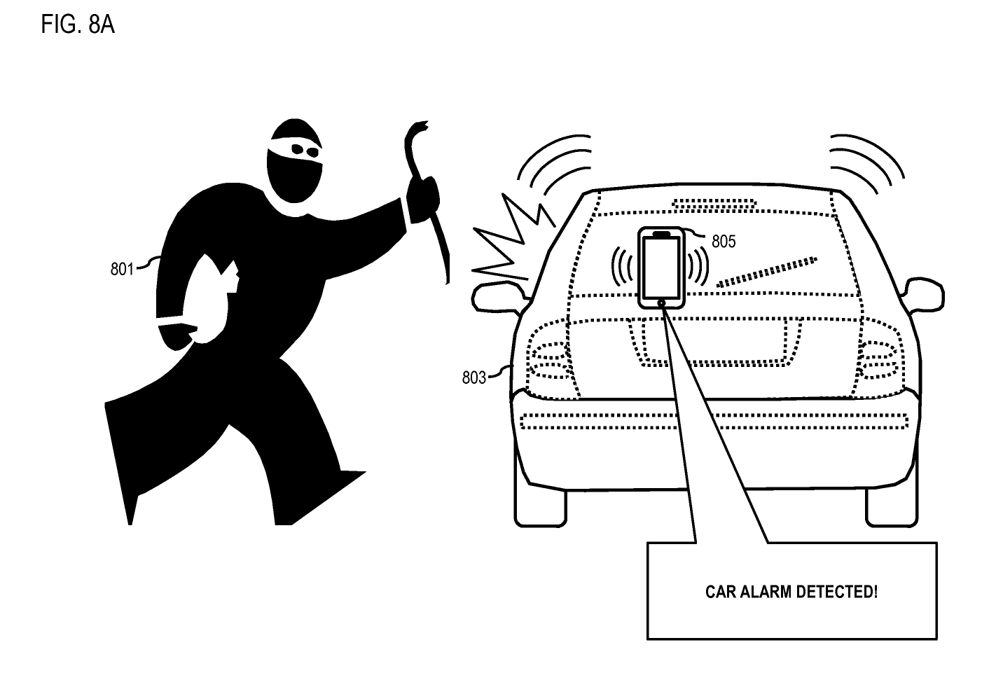

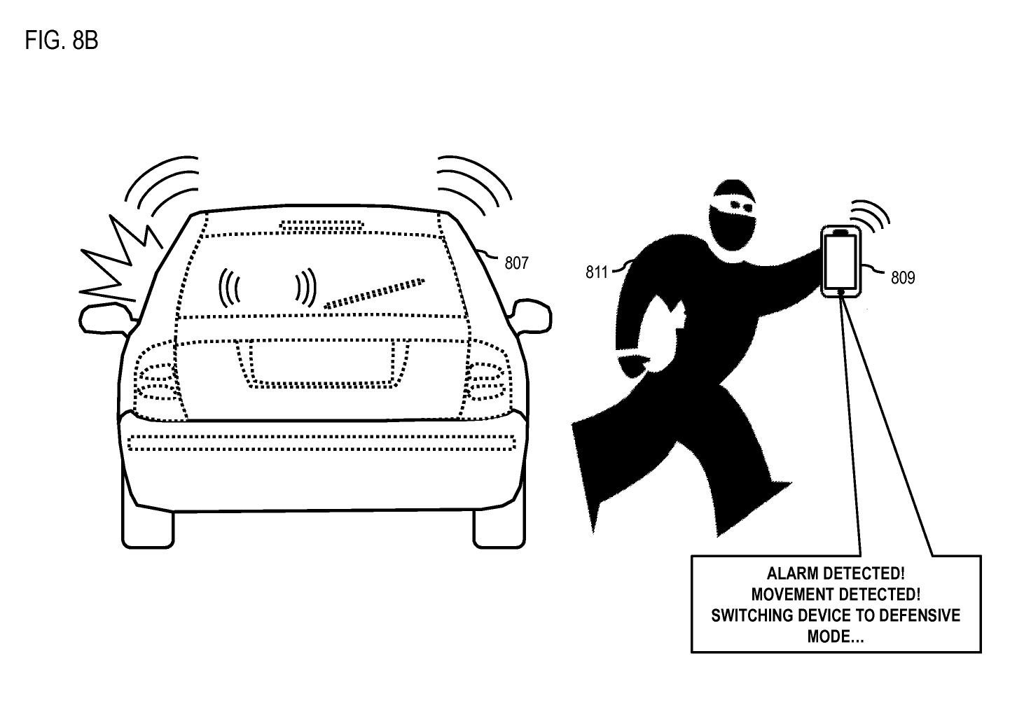

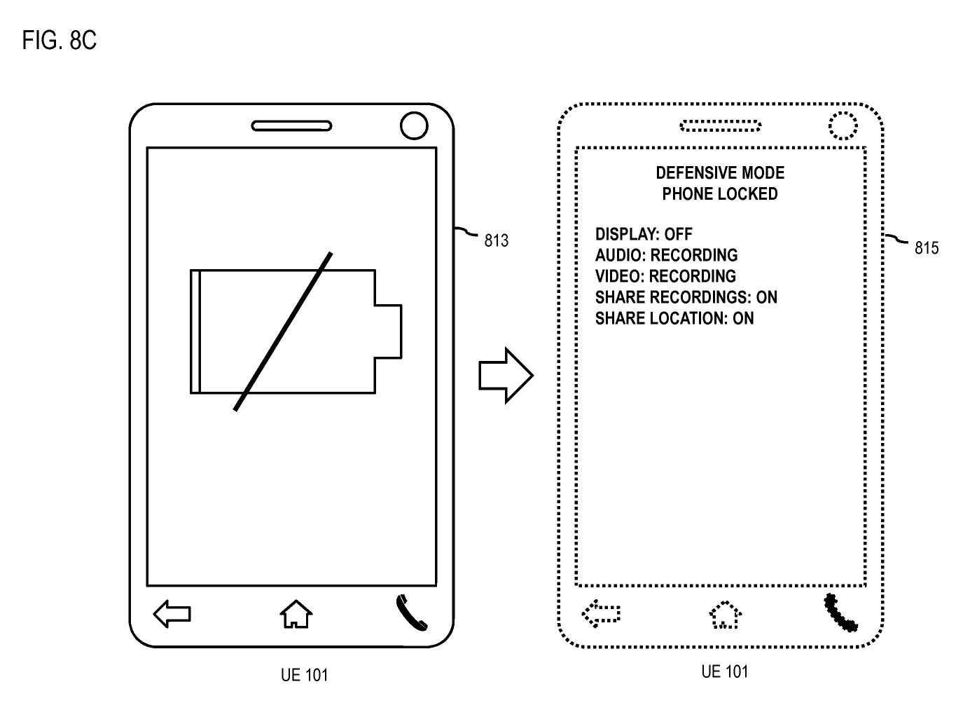

FIGS. 8 A-C are pictorial representations of a scenario wherein the identification platform 109 triggers a defensive operating mode in a UE 101 upon detecting an alarm and a movement of a UE 101, according to one example embodiment. In one scenario, thief A [801] breaks into vehicle X [805], whereby the identification platform 109 activates the vehicle alarm. The identification platform 109 then transmits the alarm information to the at least one UE 101 [805] within vehicle X [803]. The UE 101 [805] detects the alarm information via one or more sensors [805]. In one embodiment, the alarm being triggered means that the UE 101 is in a hostile environment, with high risk of being stolen. Then, the UE 101 may automatically initiate a defensive operating mode and may also initiate a sound recording and/or a front camera picture taking and/or a video recording. In FIG. 8B, thief A [811] steals the UE 101 from vehicle X [807], at which point the identification platform 109 via one or more sensors detects the movement of the UE 101 [809]. Subsequently, the identification platform 109 switches the UE 101 [809] to a defensive operating mode based, at least in part, on the proximity of UE 101 [809] from the vehicle [807]. FIG. 8C is a user interface representation of a UE 101 in a defensive operating mode. The UE 101 may cause a presentation of a false output by switching off the display and by presenting an empty battery indication [813]. On the contrary, when a UE 101 is in a defensive mode the screen is locked, the display is switched off, the audio and video recording is activated, and the recorded audio and video may be shared with a cloud service provider [815].

The processes described herein for triggering a defensive operating mode in a device upon detection of an alarm and a movement of a device may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

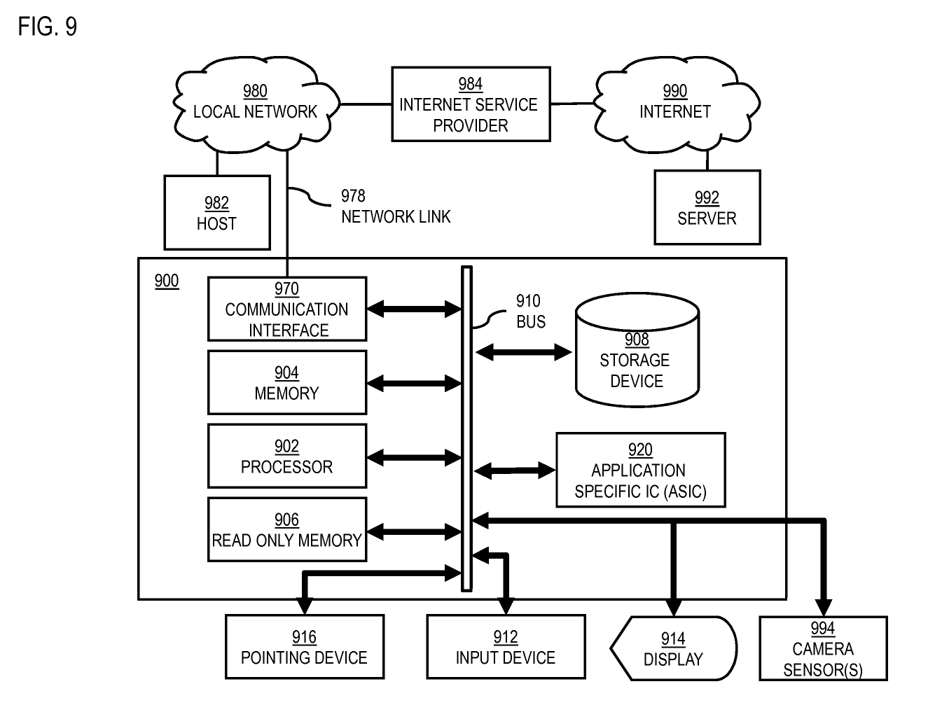

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to trigger a defensive operating mode in a device upon detection of an alarm and a movement of a device as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of triggering a defensive operating mode in a device upon detection of an alarm and a movement of a device.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to trigger a defensive operating mode in a device upon detection of an alarm and a movement of a device. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 900 also includes a memory 904 coupled to bus 910. The memory 904, such as a random access memory (RAM) or any other dynamic storage device, stores information including processor instructions for triggering a defensive operating mode in a device upon detection of an alarm and a movement of a device. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for triggering a defensive operating mode in a device upon detection of an alarm and a movement of a device, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914, and one or more camera sensors 994 for capturing, recording and causing to store one or more still and/or moving images (e.g., videos, movies, etc.) which also may comprise audio recordings. In some embodiments, for example, in embodiments in which the computer system 900 performs all functions automatically without human input, one or more of external input device 912, display device 914 and pointing device 916 may be omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 107 for triggering a defensive operating mode in a device upon detection of an alarm and a movement of a device to the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to trigger a defensive operating mode in a device upon detection of an alarm and a movement of a device as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of triggering a defensive operating mode in a device upon detection of an alarm and a movement of a device.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to trigger a defensive operating mode in a device upon detection of an alarm and a movement of a device. The memory 1005 also stores the data associated with or generated by the execution of the inventive steps.

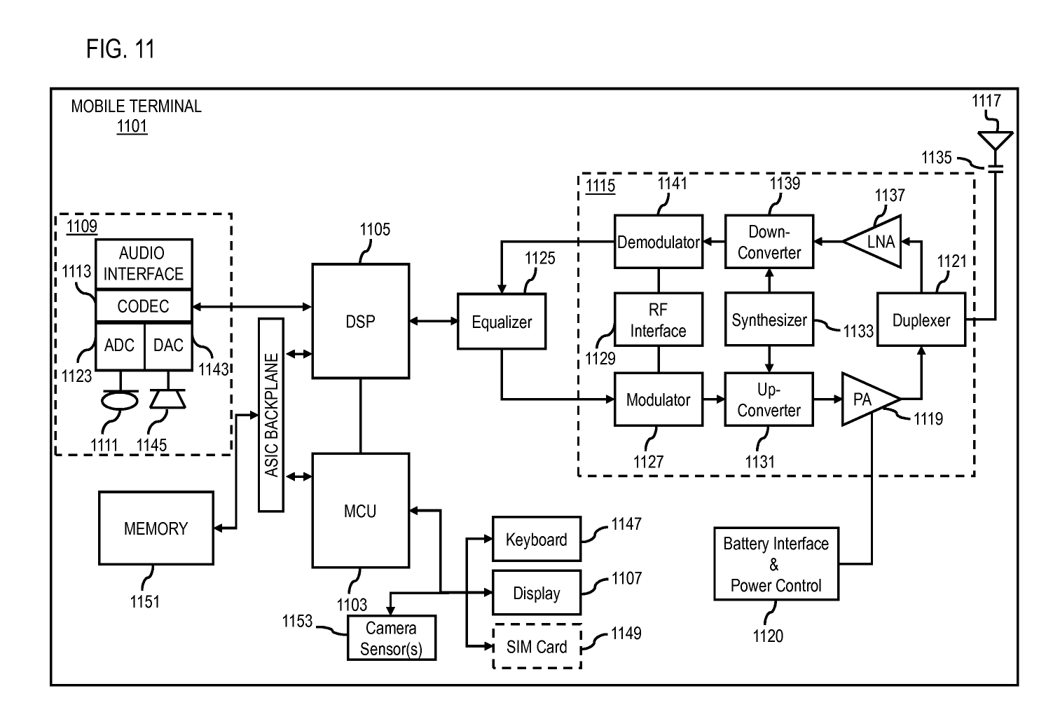

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of triggering a defensive operating mode in a device upon detection of an alarm and a movement of a device. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of triggering a defensive operating mode in a device upon detection of an alarm and a movement of a device. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to trigger a defensive operating mode in a device upon detection of an alarm and a movement of a device. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Further, one or more camera sensors 1153 may be incorporated onto the mobile station 1101 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a detection of at least one notification within proximity of at least one device;
a detection of at least one movement of the at least one device after the detection; and
an initiation of at least one alternative operating mode for the at least one device based, at least in part, on the at least one notification and the at least one movement.

2. A method of claim 1, wherein the at least one notification is associated with at least one alarm of at least one vehicle, at least one structure, or a combination thereof, and wherein the at least one device is located within the at least one vehicle, the at least one structure, or a combination thereof.

3. A method of claim 2, wherein the (1) data and/or (2) information and/or (3) at least one signal are further based, at least in part, on the following:
a transmission of at least one message regarding the at least one alarm to at least one neighboring vehicle, at least one neighboring structure, or a combination thereof,
wherein the at least one message causes, at least in part, an initiation of the least one alternative operating mode for at least one other device associated with the at least one neighboring vehicle, the at least one neighboring structure, or a combination thereof.

4. A method of claim 1, wherein the (1) data and/or (2) information and/or (3) at least one signal are further based, at least in part, on the following:
at least one determination that the at least one alarm has not been disarmed within a predetermined time period to cause, at least in part, the initiation of the at least one alternative mode of operation.

5. A method of claim 1, wherein the (1) data and/or (2) information and/or (3) at least one signal are further based, at least in part, on the following:
at least one determination that the at least one movement is beyond one or more distance criteria to cause, at least in part, the initiation of the at least one alternative mode of operation.

6. A method of claim 1, wherein the (1) data and/or (2) information and/or (3) at least one signal are further based, at least in part, on the following:
a detection of at least one authorized user within proximity of the at least one device that is in the at least one alternative mode of operation; and
causing at least one of: (a) a return to at least one normal operating mode; and (b) a presentation of prompt requesting authorization to return to the at least one normal operating mode.

7. A method of claim 6, wherein the detection of the at least one authorized user is by at least one biometric technology, and wherein the at least one biometric technology includes, at least in part, a voice recognition technology, a facial recognition technology, or a combination thereof.

8. A method of claim 1, wherein the at least one alternative operating mode includes, at least in part, (a) a deactivation of at least one display of the at least one device; (b) a deactivation of at least one power button of the at least one device; (c) an activation of a location recording, a media recording, or a combination thereof; (d) an activation of a sharing the location recording, the media recording, or a combination thereof with one or more users, one or more authorities, one or more services, or a combination thereof; or (e) a combination thereof.

9. A method of claim 1, wherein the (1) data and/or (2) information and/or (3) at least one signal are further based, at least in part, on the following:
a detection of at least one neighboring device; and
an initiation of the at least one alternative operating mode at the least one neighboring device based, at least in part, on the initiation of the alternative operating mode at the at least one device.

10. A method of claim 1, wherein the (1) data and/or (2) information and/or (3) at least one signal are further based, at least in part, on the following:
at least one determination of at least one contextual environment associated with the at least one alarm,
wherein the initiation of the at least one alternative operating mode, a selected type of the at least one alternative operating mode, or a combination thereof is based, at least in part, on the at least one contextual environment.

11. An apparatus comprising:
at least one processor; and
at least one memory including computer program code for one or more programs,
the at least one memory and the computer program code configured to, with the at least one processor, cause the apparatus to perform at least the following,
cause, at least in part, a detection of at least one notification of at least one alarm within proximity of at least one device;
cause, at least in part, a detection of at least one movement of the at least one device after the detection; and
cause, at least in part, an initiation of at least one alternative operating mode for the at least one device based, at least in part, on the at least one notification and the at least one movement.

12. An apparatus of claim 11, wherein the at least one notification is associated with at least one alarm of at least one vehicle, at least one structure, or a combination thereof, and wherein the at least one device is located within the at least one vehicle, the at least one structure, or a combination thereof.

13. An apparatus of claim 12, wherein the apparatus is further caused to:
cause, at least in part, a transmission of at least one message regarding the at least one alarm to at least one neighboring vehicle, at least one neighboring structure, or a combination thereof,
wherein the at least one message causes, at least in part, an initiation of the least one alternative operating mode for at least one other device associated with the at least one neighboring vehicle, the at least one neighboring structure, or a combination thereof.

14. An apparatus of claim 11, wherein the apparatus is further caused to:
determine that the at least one alarm has not been disarmed within a predetermined time period to cause, at least in part, the initiation of the at least one alternative mode of operation.

15. An apparatus of claim 11, wherein the apparatus is further caused to:
determine that the at least one movement is beyond one or more distance criteria to cause, at least in part, the initiation of the at least one alternative mode of operation.

16. An apparatus of claim 11, wherein the apparatus is further caused to:
cause, at least in part, a detection of at least one authorized user within proximity of the at least one device that is in the at least one alternative mode of operation; and
cause at least one of: (a) a return to at least one normal operating mode; and (b) a presentation of prompt requesting authorization to return to the at least one normal operating mode.

17. An apparatus of claim 11, wherein the apparatus is further caused to:
cause, at least in part, a detection of at least one neighboring device; and
cause, at least in part, an initiation of the at least one alternative operating mode at the least one neighboring device based, at least in part, on the initiation of the alternative operating mode at the at least one device.

18. A computer-readable storage medium carrying one or more sequences of one or more instructions which, when executed by one or more processors, cause an apparatus to at least perform the following steps:
cause, at least in part, a detection of at least one notification within proximity of at least one device;
cause, at least in part, a detection of at least one movement of the at least one device after the detection; and
cause, at least in part, an initiation of at least one alternative operating mode for the at least one device based, at least in part, on the at least one notification and the at least one movement.

19. A computer-readable storage medium of claim 18, wherein the at least one notification is associated with at least one alarm of at least one vehicle, at least one structure, or a combination thereof, and wherein the at least one device is located within the at least one vehicle, the at least one structure, or a combination thereof.

20. A computer-readable storage medium of claim 19, wherein the apparatus is further caused to:
cause, at least in part, a transmission of at least one message regarding the at least one alarm to at least one neighboring vehicle, at least one neighboring structure, or a combination thereof,
wherein the at least one message causes, at least in part, an initiation of the least one alternative operating mode for at least one other device associated with the at least one neighboring vehicle, the at least one neighboring structure, or a combination thereof.

21.-48. (canceled)
